(19) United States
(12) Patent Application Publication
(10) Pub. No.: US 2010/0255821 A1
(43) Pub. Date: Oct. 7, 2010

(54) MOBILE DEVICE WITH NAVIGATION FUNCTION AND METHOD THEREOF

(75) Inventors: HSIN-NAN HU, Tu-Cheng (TW); CHAO-FENG MA, Shenzhen City (CN); KUAN-HONG HSIEH, Tu-Cheng (TW); XIAO-GUANG LI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/434,678

(22) Filed: May 3, 2009

(30) Foreign Application Priority Data
Apr. 2, 2009 (CN) 200910301317.8

(51) Int. Cl. H04M 3/42; H04W 4/02

(52) U.S. Cl. 455/414.1; 455/556.1

(57) ABSTRACT

A navigation method of the mobile device is provided, wherein the mobile device comprises a GPS unit, the step comprising: receiving a message sent by a requester mobile device; identifying whether the received message is a route inquiry message according to a message type flag; determining a departure location and a destination of the inquiry route segment in the route inquiry message according to an address flag; acquiring route information between the determined departure location and departure of the route inquiry segment according to a GPS unit; generating a reply message including the acquired route information, and sending the generated reply message to the requester mobile device. A mobile device with navigation function is also provided.

### BACKGROUND

1. Technical Field

The present disclosure relates to a mobile device with a navigation function and a method thereof.

2. Description of Related Art

In general, mobile devices with Global Position System (GPS) navigation function are useful but expensive, so not everyone can afford one. However, a user with one can share the function manually through message functions with a user who does not have the device with GPS. However, using a manual method is not convenient and is time consuming, and prone to human error.

Therefore, what is needed is a mobile device with an automatic method for sharing navigation functions and a navigation method.

### BRIEF DESCRIPTION OF THE DRAWINGS

FIG. 1 is a schematic diagram of a system, including two mobile devices, for receiving and sending messages via a wireless network in accordance with an exemplary embodiment.

FIG. 2 is a block diagram of the hardware infrastructure of a replier mobile device 20 of FIG. 1 in accordance with an exemplary embodiment.

FIG. 3 is a flowchart of a navigation method implemented by the replier mobile device 20 of FIG. 2 in accordance with an exemplary embodiment.

### DETAILED DESCRIPTION

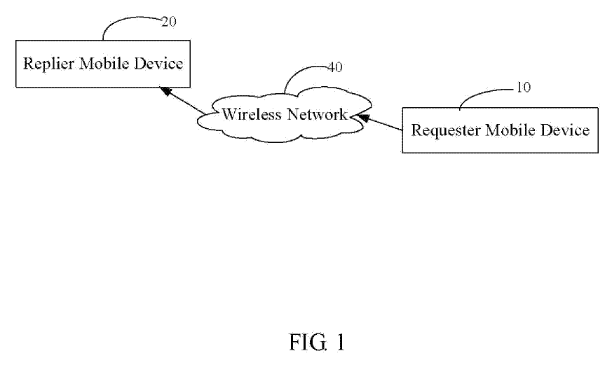

FIG. 1 is a schematic diagram of a system, including two mobile devices, for receiving and sending messages via a wireless network in accordance with an exemplary embodiment. In general, the system includes a plurality of requester mobile devices 10, a plurality of replier mobile devices 20, and a wireless network 40. In the exemplary embodiment, the disclosure only takes one requester mobile device 10 and one replier mobile device 20 to describe the principles of the invention. The requester mobile device 10 is a mobile device without a Global Position System (GPS) navigation function, and the replier mobile device 20 is a mobile device with the GPS navigation function. The requester mobile device 10 communicates with the replier mobile device 20 via the wireless network 40. The wireless network 40 can be General Packet Radio Service (GPRS) network, Global System for Mobile Communications (GSM) network, Code Division Multiple Access (CDMA) network, and so on.

When the requester mobile device 10 wants to acquire information on a route segment, the requester mobile device 10 sends an route inquiry message to the replier mobile device 20. The replier mobile device 20 acquires the information of the inquiry route segment via its GPS function according to the route inquiry message, automatically edits a reply message including the acquired route information, and sends the edited message to the requester mobile device 10.

The route inquiry message has a predetermined message format. That is, the route inquiry message includes a message type flag and an address flag.

The message type flag is configured to indicate the type of the route inquiry message. In the exemplary embodiment, there are two methods to indicate the message type. The first method is for automatically bundling predetermined content into the message heading of the route inquiry message to indicate the message type, such as “route consultation”, “route inquiry”, and so on.

The second method is for setting a predetermined suffix to distinguish the route inquiry message from other type messages, such as, “.Irm”. In other exemplary embodiments, the requester mobile device 10 can also apply other methods to indicate the type of the route inquiry message, for example, setting predetermined keywords in the route inquiry message to indicate the type of the route inquiry message.

The address flag is configured to indicate a departure location and a destination of the route segment in the route inquiry message. In the exemplary embodiment, there are two methods to indicate the departure location and the destination of the route segment. The first method automatically bundles predetermined keywords into the content of the message to indicate the departure location and the destination. For example, when editing the route inquiry message, the predetermined keywords, such as “departure” and “destination”, will are automatically loaded into the content of the message; accordingly, the user can input the departure location behind the predetermined keyword “departure” and the destination behind the predetermined keyword “destination”.

The second method sets an identification sequence to indicate the departure location and the destination. For example, the requester mobile device 10 can define a first location as the departure location, and a second location as the destination. In other exemplary embodiment, the user may input only one location; the requester mobile device 10 will set the input location as the departure location, and set the location of the replier mobile device 20 as the destination. Also, the requester mobile device 10 can apply other methods to indicate the address flag.

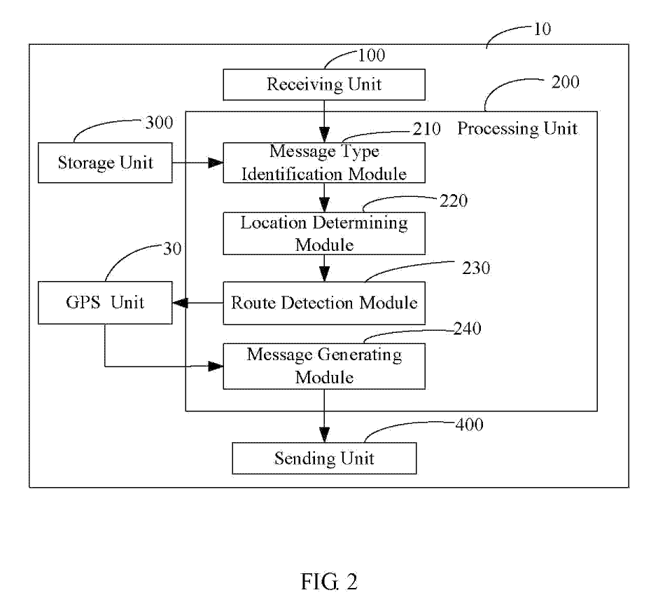

FIG. 2 is a block diagram of the hardware infrastructure of a replier mobile device 20 of FIG. 1 in accordance with an exemplary embodiment. The replier mobile device 20 includes a receiving unit 100, a processing unit 200, a storage unit 300, and a GPS unit 30. The GPS unit 30 is configured to determine a current location or a route segment according to a received satellite signal. The receiving unit 100 is configured to receive messages sent by the requester mobile device 10 or other mobile devices.

The processing unit 200 includes a message type identification module 210, a location determining module 220, a route detection module 230, and a message generating module 240.

The message type identification module 210 is configured to identify whether the received message is a route inquiry message according to the message type flag. For example, the message type identification module 210 obtains the message heading or the suffix of the message to identify the message type.

In the exemplary embodiment, the processing unit 200 deals with the received message in a general manner if the message type identification module 210 identifies that the received message is not a route inquiry message. The general manner includes, but is not limited to, displaying the message, forwarding the message, or replying the message, and so on.

The location determining module 220 is configured to determine a departure location and a destination in the route inquiry message according to the address flag. For example, the location determining module 220 identifies the predetermined keywords or the identification sequence to determine the departure location and the destination.

The route detection module 230 is configured to acquire route information between the departure location and the destination according to the GPS unit 30.

The message generating module 240 is configured to automatically generate a reply message including the acquired route, and send the generated message to the requester mobile device 10 via the sending unit 400. In the exemplary embodiment, the reply message can be generated in two methods. The first method is for editing the determined route in a text form to generate a text reply message including critical route information. The second method is for obtaining a map of the area including the departure location and the destination via the GPS unit 30 to generate a multi-media reply message. The critical route information of the determined route includes, but is not limited to, road names, walking distance, driving distance, orientation, and landmarks, and so on. The critical route information of the determined route has been obtained from the GPS unit 30, which delivers the critical route information by voice and/or text.

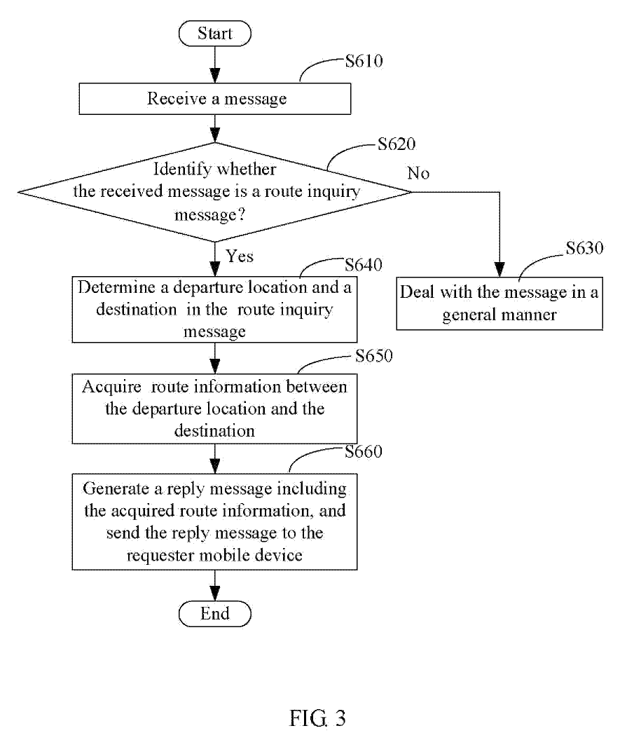

FIG. 3 is a flowchart of a navigation method implemented by the replier mobile device 20 of FIG. 2 in accordance with an exemplary embodiment.

In step S610, the receiving unit 100 receives messages sent by the requester mobile device 10 or other mobile devices.

In step S620, the message type identification module 210 identifies whether the received message is a route inquiry message according to according to the message type flag.

In step S630, the processing unit 200 deals with the received message in a general manner if the received message is not a route inquiry message.

In step S640, the location determining module 220 determines a departure location and a destination in the route inquiry message according to the address flag if the received message is a route inquiry message.

In step S650, the route detection module 230 acquires route information between the departure location and the destination via the GPS unit 30.

In step S660, the message generating module 240 automatically generates a reply message including the acquired route information, and sends the generated reply message to the requester mobile device 10 via the sending unit 400.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A mobile device with navigation function, comprising:
a receiving unit capable of receiving messages sent by a requester mobile device
a GPS unit;
a sending unit; and
a processing unit comprising:
a message type identification module capable of identifying whether the received message is a route inquiry message according to a message type flag in the message;
a location determining module capable of determining a departure location and a destination of the inquiry route segment in the route inquiry message according to an address flag in the message;
a route detection module capable of acquiring route information between the departure location and the destination via the GPS unit; and
a message generating module capable of automatically generating a reply message including the acquired route information, and sending the generated reply message to the requester mobile device via the sending unit.

2. The mobile device as claim 1, wherein the message identification module is capable of identifying whether the obtained content of the message heading includes the predetermined keywords according to the message type flag to determine whether the received message is a route inquiry message.

3. The mobile device as claim 1, wherein the message identification module is further capable of identifying whether the suffix name of the received massage is a predetermined suffix according to the message type flag to determine whether the received message is a route inquiry message.

4. The mobile device as claim 1, wherein the location determining module is capable of determining a departure location and a destination according to the address flag if the route inquiry message includes two locations.

5. The mobile device as claim 1, wherein the location determining module is further capable of determining the location in the route inquiry message as the departure location, and determining the location of the mobile device as the destination according to the address flag if the route inquiry message includes only one location.

6. The mobile device as claim 1, wherein the message generating module is capable of editing the route information in a text form to generate a text reply message.

7. The mobile device as claim 1, wherein the message generating module is further capable of obtaining a map of the area including the departure location and the destination via the GPS unit to generate a multi-media reply message.

8. A navigation method of the mobile device, wherein the mobile device comprises a GPS unit, the method comprising:
receiving a message sent by a requester mobile device;
identifying whether the received message is a route inquiry message according to a message type flag in the message;
determining a departure location and a destination of the inquiry route segment in the route inquiry message according to an address flag in the message;
acquiring route information between the departure location and the destination according to the GPS unit; and
generating a reply message including the acquired route information, and sending the generated reply message to the requester mobile device.

9. The method as described in claim 8, wherein the identifying message type step further comprises:
identifying whether the obtained content of the message heading includes the predetermined keywords according to the message type flag to determine whether the received message is a route inquiry message.

10. The method as described in claim 8, wherein the identifying message type step further comprises:
identifying whether the suffix name of the received massage is a predetermined suffix according to the message type flag to determine whether the received message is a route inquiry message.

11. The method as described in claim 8, wherein the determining location step further comprises:
determining a departure location and a destination according to the address flag in the route inquiry message if the route inquiry message includes two locations.

12. The method as described in claim 8, wherein the determining location step further comprises:
determining the location of the route inquiry message as the departure location and the location of the mobile device as the destination according to the address flag if the route inquiry message includes only one location.

13. The method as described in claim 8, wherein the generating reply message step further comprises:
editing the route information in a text form to generate a text reply message.

14. The method as described in claim 8, wherein the generating reply message step further comprises:
obtaining a map of the area including the departure location and the destination to generate a multi-media reply message.
